(19) United States
(12) Patent Application Publication
(10) Pub. No.: US 2019/0250616 A1
(43) Pub. Date: Aug. 15, 2019

(54) Performing a service on an autonomous vehicle enroute to a destination

(71) Applicant: Madhusoodhan Ramanujam, Portland, OR (US)

(72) Inventor: Madhusoodhan Ramanujam, Portland, OR (US)

(21) Appl. No.: 16/393,553

(22) Filed: Apr. 24, 2019

(51) Int. Cl. G05D 1/00; G07C 5/08

(52) U.S. Cl. CPC G05D 1/0088; G05D 1/0231; G05D 2201/0213; G07C 5/085

(57) ABSTRACT

Technology is described for an autonomous vehicle. The autonomous vehicle may provide commands to drive the autonomous vehicle along a route to a destination. The autonomous vehicle may determine that a service is to be performed on the autonomous vehicle when the autonomous vehicle is driving along the route to the destination. The autonomous vehicle may identify a service center that is in proximity to the route taken by the autonomous vehicle. The autonomous vehicle may provide commands to divert the autonomous vehicle from the route and drive to the service center to enable the service to be performed on the autonomous vehicle.

### BACKGROUND

Autonomous vehicles, such as self-driving cars, may operate with minimal or substantially no human input. For example, a passenger may enter a destination at a console of the autonomous vehicle, such as a touch screen, and the autonomous vehicle may navigate itself to the destination (e.g., a movie theater) by sensing its surrounding environment. The autonomous vehicle may sense its surroundings using a combination of sensors, cameras, radar, light detection and ranging (LIDAR), global positioning system (GPS), etc.

Autonomous vehicles offer a large number of benefits as compared to traditional automobiles. For example, autonomous vehicles may reduce traffic collisions due to the autonomous vehicle's increased reliability and improved reaction time as compared to human drivers. Autonomous vehicles may increase roadway capacity and reduce traffic congestion. In addition, passengers that are under age, elderly, disabled, intoxicated, or otherwise impaired may benefit from traveling in autonomous vehicles.

### BRIEF DESCRIPTION OF THE DRAWINGS

FIG. 1 illustrates operations for performing a service on an autonomous vehicle enroute to a destination according to an example of the present technology.

FIG. 2 is an illustration of a networked system for performing services on an autonomous vehicle enroute to a destination according to an example of the present technology.

FIG. 3 illustrates a system and related operations for performing a service on an autonomous vehicle enroute to a destination according to an example of the present technology.

FIG. 4 illustrates a system and related operations for performing service(s) on an autonomous vehicle enroute to a destination according to an example of the present technology.

FIG. 5 illustrates a route that is traveled by an autonomous vehicle according to an example of the present technology.

FIG. 6 depicts functionality of an autonomous vehicle operable to divert from a route and drive to a service center to enable a service to be performed on the autonomous vehicle according to an example of the present technology.

FIG. 7 depicts functionality of an autonomous vehicle operable to divert from a route and drive to a service center to enable a service to be performed on the autonomous vehicle according to an example of the present technology.

FIG. 8 depicts functionality of an autonomous vehicle operable to divert from a route and drive to a plurality of service center to enable service(s) to be performed on the autonomous vehicle according to an example of the present technology.

FIG. 9 illustrates an autonomous vehicle according to an example of the present technology.

FIG. 10 is a block diagram that provides an example illustration of a computing device that may be employed in the present technology.

### DETAILED DESCRIPTION

Technology is described for performing a service on an autonomous vehicle enroute to a destination. One example of an autonomous vehicle is a self-driving truck (or driverless truck) that transports goods between geographic locations. The autonomous vehicle may detect a service to be performed on the autonomous vehicle enroute to the destination. The autonomous vehicle may select a service center to perform the service on the autonomous vehicle. The autonomous vehicle may provide commands to divert the autonomous vehicle from the route to the service center to enable performance of the service on the autonomous vehicle. Then, the autonomous vehicle may provide commands to drive the autonomous vehicle from the service center back to the route and continue driving along the route to the destination.

In one example, the service to be performed on the autonomous vehicle may include refueling or recharging the autonomous vehicle. The autonomous vehicle may be gasoline-powered and the service may include filling the autonomous vehicle with gasoline. Alternatively, the autonomous vehicle may be electric-powered and the service may include recharging the autonomous vehicle's batteries. In another example, the service may include performing maintenance or repairs on the autonomous vehicle. As yet another example, the service may include cleaning the autonomous vehicle (e.g., at a car wash).

In one configuration, the autonomous vehicle may include internal systems that automatically detect when a service is to be performed on the autonomous vehicle while the autonomous vehicle is enroute to the destination. For example, the autonomous vehicle may detect when a gasoline level is below a defined threshold (e.g., below a quarter tank) or a battery level is below a defined threshold (e.g., less than 10%) while the autonomous vehicle is driving to the destination. In another example, the autonomous vehicle may detect when a current range (in miles or kilometers) of the autonomous vehicle is below a defined threshold while the autonomous vehicle is driving to the destination. In these cases, the autonomous vehicle may detect that the service of refilling a gasoline tank of the autonomous or recharging a battery of the autonomous vehicle is to be performed. In another example, the internal systems may detect that a specific type of maintenance (e.g., a tire rotation, oil change, brake pad replacement) is to be performed on the autonomous vehicle, and the specific type of maintenance may be detected while the autonomous vehicle is enroute to the destination.

In one configuration, the autonomous vehicle may select or identify the service center to perform the service on the autonomous vehicle. The service center may be alongside or in proximity to the route being taken by the autonomous vehicle. The service center may be “in proximity” when the service center is 1 mile, 2 miles, 5 miles, 10 miles, 20 miles or more away from the route, depending on the geography surrounding the autonomous vehicle's current position on the route. In other words, the service center may be within a certain distance from the route taken by the autonomous vehicle. For example, the service center may be within the current range of the autonomous vehicle. The service center may include, but is not limited to, a fuel center for refueling or recharging the autonomous vehicle, a maintenance center for performing maintenance on the autonomous vehicle, or a car wash for cleaning the autonomous vehicle. As an example, the autonomous vehicle may select a previously visited service center for performing the service on the autonomous vehicle. For example, the autonomous vehicle may select a service center at which the autonomous vehicle previously refueled or recharged. The autonomous vehicle may select the service center based on customer reviews, price, distance, etc. Further, the autonomous vehicle may select the service center based on capabilities of the service center. For example, the autonomous vehicle may select a service center that offers a certain type of gasoline or fuel, or that offers a certain charging capability.

In one example, the autonomous vehicle may send a notification to a user associated with the autonomous vehicle of the service to be performed on the autonomous vehicle and the service center selected to perform the service. The autonomous vehicle may send the notification to the user's computing device. The autonomous vehicle may receive an authorization from the user to divert from the route and drive to the service center to enable performance of the service on the autonomous vehicle. Based on the authorization received from the user, the autonomous vehicle may drive to the service center to enable the service to be performed, and then drive back to the route to proceed to the destination.

When the autonomous vehicle arrives at the service center, a data matrix attached to the autonomous vehicle may be scanned by a service provider's computing device (e.g., a tablet device) at the service center. For example, the data matrix may include a quick response (QR) code or a barcode attached to the autonomous vehicle's windshield. The data matrix may store information about the user (e.g., an owner of the autonomous vehicle), such as the user's name, email address, bank information, vehicle information, service history, etc. Non-limiting examples of the service provider that works at the service center may include a fuel station attendant or a maintenance worker. In one configuration, the service provider's computing device may scan the data matrix attached to the autonomous vehicle, and the computing device may generate a message indicating that the autonomous vehicle has arrived at the service center. In addition, the message may include a request for the user to specify a type of service to be performed on the autonomous vehicle. The service provider's computing device may send the message to the user using the information about the user included in the matrix code. The message may include a digital signature or another security mechanism to prove that the sender of the message is indeed a service provider that is authenticated to provide services at the service center. In other words, security credentials included in the message may assure the user that the autonomous vehicle is being handled by an authentic service provider at the service center.

In one example, in response to the message received from the service provider's computing device, the user may reply with a message authorizing the service provider at the service center to perform the service on the autonomous vehicle based in part on the security mechanism provided by the service provider. In addition, the message may include specific instructions for the service provider when performing the service. As non-limiting examples, the instructions may be for refueling or recharging the autonomous vehicle, checking various fluids in the autonomous vehicle, etc.

In one configuration, in conjunction with the user sending the message authorizing the service to be performed, the user may instruct the autonomous vehicle to perform a task to enable the service provider to perform the service. As a non-limiting example, the user may instruct the autonomous vehicle to open a fuel door so that the autonomous vehicle can be recharged or refueled. As another example, the user may authorize the autonomous vehicle to be controlled by the service provider within a predefined area (e.g., a radius of 50 feet), so that the service provider can move the autonomous vehicle into a service garage in order to perform the service. The autonomous vehicle may receive the instructions from the user and perform a requested task accordingly.

In one example, the service provider may acknowledge the instructions received from the user and perform the service on the autonomous vehicle accordingly. The service provider may send a message to the user when the service is complete. The message may include a summary of the service performed and a cost associated with the service. The user may receive the message and authorize payment for the service. The service provider may charge the user using the billing information in the data matrix. After the service has been completed at the service center, the autonomous vehicle may drive back to the route and continue driving along the route to the destination.

As a non-limiting example, a self-driving electric truck may be transporting goods from an origin to a destination along a route. The route between the origin and the destination may span a distance of 2000 miles. However, a range for the self-driving electric truck may be 500 miles, at which point the self-driving electric truck is to be recharged. In this example, when traveling along the route to the destination, the self-driving electric truck may have to stop to recharge at least four times. The self-driving electric truck may monitor in real-time a current range when driving along the route to the destination, and when the current range of the self-driving electric truck falls below a certain threshold (e.g., 50 miles), the self-driving electric truck may select or identify a service center that is capable of recharging the self-driving electric truck. The identified service center may be along the route or in proximity (within a certain distance) to the route. In other words, the self-driving electric truck may select a service center that is two miles from the route, as opposed to a service center that is 20 miles from the route, if possible. The self-driving electric truck may divert from the route and drive to the service center. After the self-driving electric truck is recharged, the self-driving electric truck may drive back to the route (i.e., back to the point at which the self-driving electric truck diverted from the route to drive to the service center) and continue along the route to the destination. The self-driving electric truck may repeat this process multiple times (e.g., at least four times) when driving to the destination. As a result, the self-driving electric truck may not run out of battery charge when traveling to the destination. Further, the self-driving electric truck may stop at the service center(s) alongside the route to recharge in an automated manner with minimal human intervention.

In previous solutions, when a battery level or current range of the self-driving electric truck would reach a certain threshold, a human operator of the self-driving electric truck would have to notice that the battery level or current range fell below the certain threshold. Further, the human operator would manually locate a charging station, and switch the self-driving electric truck from operating in an autonomous driving mode to a manual driving mode. The human operator would manually drive the self-driving electric truck off the route and to the charging station while operating using the manual driving mode. After the self-driving electric truck was recharged, the human operator would configure the self-driving electric truck to drive to the destination while operating under the autonomous driving mode. However, in post solutions, the next time that the battery level or current range would fall below the certain threshold, the same process would have to be repeated, thereby increasing the responsibilities of the human operator.

In contrast, with the present technology, the self-driving electric truck may automatically detect when the battery level or current range falls below the certain threshold, and automatically identify or select a service center to recharge the self-driving electric truck. In the present technology, after the self-driving electric truck is recharged, the self-driving electric truck may automatically continue along the route to the destination. As a result, the present technology enables a self-driving electric truck to complete a long journey that is many times the distance of the self-driving electric truck's range, while minimizing the burden on a human operator in terms of recharging the self-driving electric truck during the journey. Further, the present technology enables a self-driving electric truck to complete a long journey without risk of running out of battery charge without a human operator present in the self-driving electric truck.

In one configuration, an autonomous vehicle may identify or select a route for driving from an origin to a destination. The autonomous vehicle may further identify a plurality of service centers along the route to the destination. The autonomous vehicle may identify the service centers, such that a distance between two adjacent service centers along the route is less than a defined range of the autonomous vehicle. The autonomous vehicle may drive along the route to the destination. When the autonomous vehicle approaches one of the identified service centers, the autonomous vehicle may divert from the route and drive to that service center to enable a service (e.g., refueling or recharging) to be performed on the autonomous vehicle. After the service is completed, the autonomous vehicle may return to the route and continue driving to the destination. The autonomous vehicle may drive to each of the identified service centers along the route to enable the service (e.g., refueling or recharging) to be performed. As a result, the autonomous vehicle may successfully drive to the destination along the route without running out of battery charge or fuel.

As a non-limiting example, a self-driving electric truck may identify a route that involves traveling 2000 miles from an origin to a destination. The self-driving electric truck may have a range of 300 miles. In this example, the self-driving electric truck may identify a plurality of service centers along (or in proximity to) the route that are approximately 300 miles away from each other. In some cases, the distance between adjacent service centers that are identified are along the route may be less than the range by a defined margin. For example, the self-driving electric truck may identify a plurality of service centers along the route that are approximately 250 miles away from each other to allow a 50-mile margin. In other words, when the self-driving electric truck has approximately 50 miles left of range, the self-driving electric truck may recharge at a service center. The self-driving electric truck may determine the service center(s) to be visited along the route when traveling to the destination, and the self-driving electric truck may provide commands to divert from the route and drive to the service center(s) accordingly. As a result, the self-driving electric truck may successfully complete the 2000-mile journey to the destination while making a number of stops at service centers along the route to recharge, thereby ensuring that the self-driving electric truck successfully completes the journey without running out of battery charge.

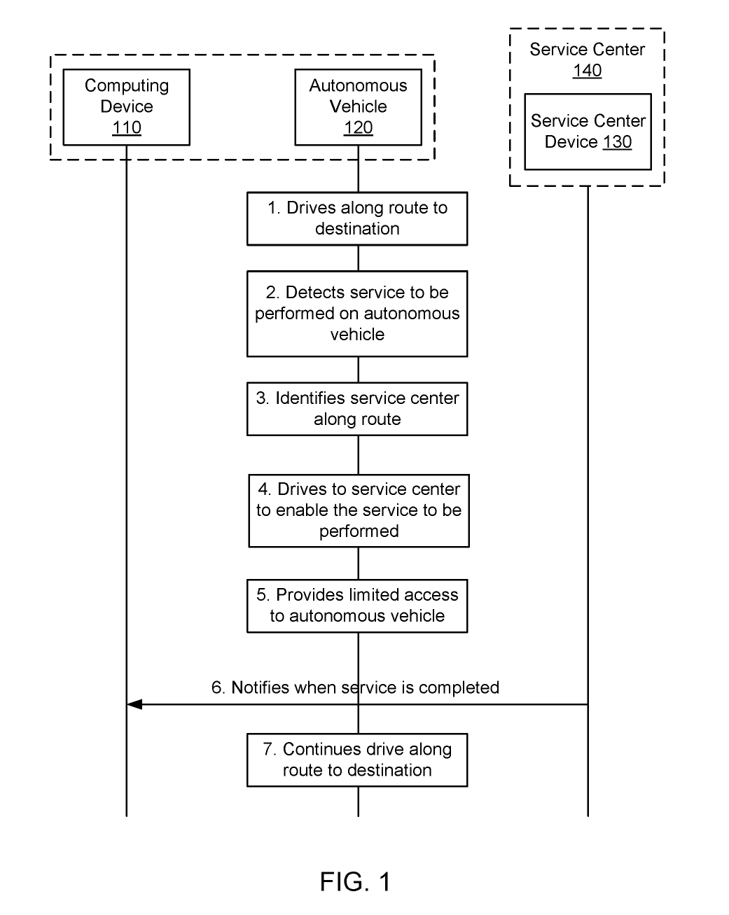

FIG. 1 illustrates operations for performing a service on an autonomous vehicle 120 enroute to a destination. For example, the autonomous vehicle 120 may be a self-driving truck that is driving autonomously along a route to the destination. The autonomous vehicle 120 may identify or select the route for driving from an origin to the destination. The autonomous vehicle 120 may provide commands to drive along the route to the destination.

In one example, the autonomous vehicle 120 may detect a service to be performed while enroute to the destination via internal systems within the autonomous vehicle 120. For example, the autonomous vehicle 120 may detect, using the internal systems, when a current range of the autonomous vehicle 120 is below a defined threshold. In this case, the service to be performed on the autonomous vehicle 120 may include recharging or refueling the autonomous vehicle 120. As another example, the autonomous vehicle 120 may detect, using the internal systems, when a specific type of maintenance is needed for the autonomous vehicle 120. In this case, the service to be performed on the autonomous vehicle 120 may include rotating the autonomous vehicle's tires, replacing the autonomous vehicle's brake pads, etc. As yet another example, the autonomous vehicle 120 may detect, using the internal systems, when a specific type of repair is needed for the autonomous vehicle 120. In this case, the service to be performed on the autonomous vehicle 120 may include providing a software fix for the autonomous vehicle 120, replacing a battery of the autonomous vehicle 120, replacing a sensor of the autonomous vehicle 120, etc.

In one example, the autonomous vehicle 120 may identify or select a service center 140 along the route to perform the service on the autonomous vehicle 120. For example, the autonomous vehicle 120 may select a particular gas station, electronic automobile charging station, vehicle repair center, etc. along the route to perform the service on the autonomous vehicle 120. The autonomous vehicle 120 may select the service center 140 that is within a defined distance from the route. In other words, the autonomous vehicle 120 may attempt to not digress from the route above a certain distance (e.g., 5 miles) to drive to the service center 140. The autonomous vehicle 120 may select the service center 140 based on previous service centers used to perform services on the autonomous vehicle 120. In addition, the autonomous vehicle 120 may select the service center 140 based on customer reviews, price, distance from the route, etc.

The autonomous vehicle 120 may drive to the service center 140 to enable performance of the service on the autonomous vehicle 120. The autonomous vehicle 120 may provide limited access to the autonomous vehicle 120 to enable a service provider at the service center 140 to perform the service. For example, the autonomous vehicle 120 may open a fuel door to allow the service provider to recharge or refuel the autonomous vehicle 120. As another example, the autonomous vehicle 120 may be driven within a predefined area (e.g., a radius of 500 feet) using a manual driving mode to enable the service provider to move the autonomous vehicle 120 into a service garage in order to perform the service.

In one example, after the service is performed, a service center device 130 associated with the service provider at the service center 140 may send a notification to a user's computing device 110 indicating that the service was successfully performed on the autonomous vehicle 120. The user associated with or carrying the computing device 110 may be within the autonomous vehicle 120 (e.g., the user may be a passenger inside the autonomous vehicle 120). Alternatively, the user and the computing device 110 may be located at a remote location (e.g., when the autonomous vehicle 120 operates at Level 4). In other words, the user carrying the computing device 100 may be within the autonomous vehicle 120 to oversee operation of the autonomous vehicle 120 but may provide minimal human control. Alternatively, the user carrying the computing device 100 may be outside the vehicle when the autonomous vehicle 120 is operating without a human operator.

In one example, after the service is performed, the autonomous vehicle 120 may drive from the service center 140 back to the route previously taken to the destination. In other words, the autonomous vehicle 120 may drive back to the point at which the autonomous vehicle 120 diverted from the route to drive to the service center 140, and then the autonomous vehicle 120 may continue along the route to the destination.

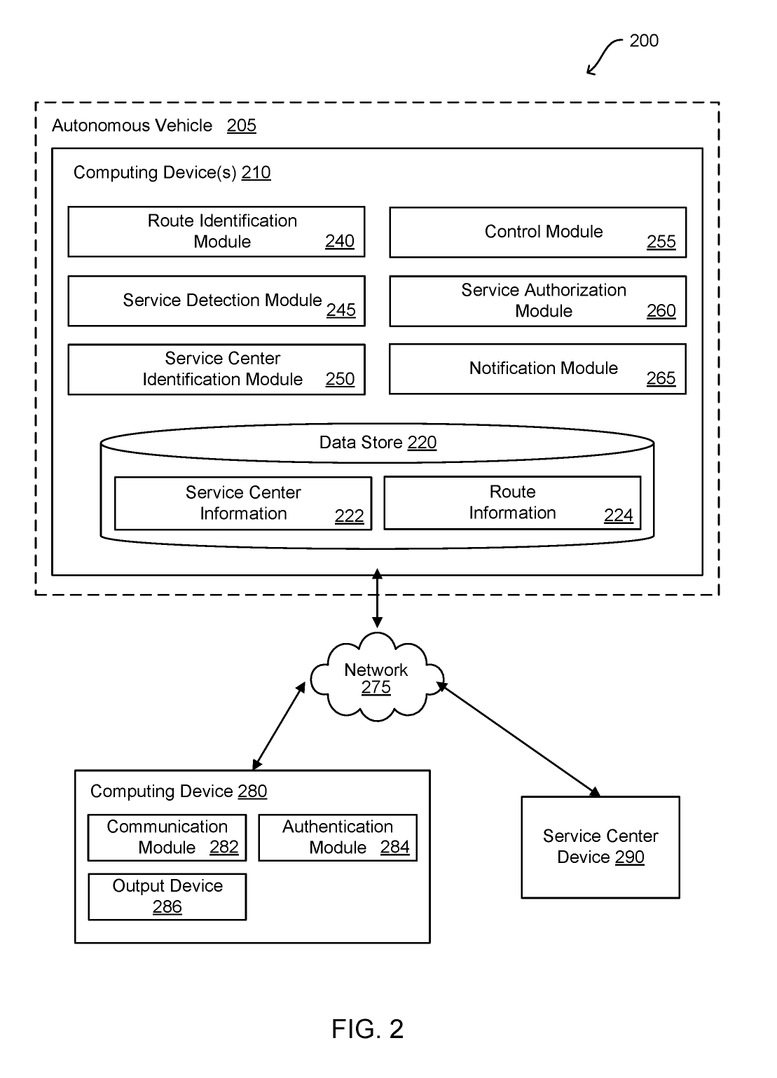

In the following discussion, a general description of an example system for performing services on an autonomous vehicle 205 enroute to a destination and the system's components are provided. The general description is followed by a discussion of the operation of the components in a system for the technology. FIG. 2 illustrates a networked environment 200 according to one example of the present technology. The networked environment 200 may include one or more computing devices 210 in data communication with a computing device 280 by way of a network 275. In one example, the computing device 210 may be included in an autonomous vehicle 205, and the computing device 280 may be a mobile device of a user associated with the autonomous vehicle 205. The network 275 may include the Internet, intranets, extranets, wide area networks (WANs), local area networks (LANs), wired networks, wireless networks, or other suitable networks, etc., or any combination of two or more such networks.

Various applications, services and/or other functionality may be executed in the computing device 210 according to varying embodiments. Also, various data may be stored in a data store 220 that is accessible to the computing device 210. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The data stored in the data store 220, for example, may be associated with the operation of the various applications and/or functional entities described below.

The data stored in the data store 220 may include service center information 222. The service center information 222 may describe a plurality of service centers in a plurality of geographic region(s). The service centers may include establishments that perform automotive services. As non-limiting examples, the service centers may include gas stations, charging stations, vehicle repair centers, vehicle maintenance centers, car wash centers, etc. The service center information 222 may include address information, contact information, reviews, prices, services that are performed, etc. for each of the plurality of service centers. In addition, the service center information 222 may include a list of service centers that were previously visited by the autonomous vehicle 205.

The data stored in the data store 220 may include route information 224. The route information 224 may include a route that is taken by the autonomous vehicle 205 to travel from on origin to a destination. For example, the route may include a list of turns, streets, freeways, etc. for traveling from the origin to the destination. The route information 224 may include a shortest-time route or a shortest-distance route for traveling from the origin to the destination.

The components executed on the computing device 210 may include a route identification module 240, a service detection module 245, a service center identification module 250, a control module 255, a service authorization module 260, a notification module 265, and other applications, services, processes, systems, engines, or functionality not discussed in detail herein.

The route identification module 240 may identify or determine the route information 224 for traveling along the route from the origin to the destination. For example, the route identification module 240 may determine a shortest-time route or a shortest-distance route for traveling from the origin to the destination. The route identification module 240 may determine the route information 224 based on input (e.g., origin, destination) from the computing device 280.

The service detection module 245 may be configured to detect that a service is to be performed on the autonomous vehicle 205. The service detection module 245 may detect that the service is needed while the autonomous vehicle 205 is traveling along the route to the destination. The service may include refueling or recharging the autonomous vehicle 205, performing a repair on the autonomous vehicle 205, performing maintenance on the autonomous vehicle 205, cleaning the autonomous vehicle 205, or other services that may be performed on the autonomous vehicle 205. In one configuration, the service detection module 245 may detect the service to be performed on the autonomous vehicle 205 when one or more internal systems in the autonomous vehicle 205 generate an alert. For example, the alert may be generated when the autonomous vehicle 205 is low on fuel or is to be recharged (e.g., based on a current rage of the autonomous vehicle 205 falling below a threshold value). In addition, the alert may be generated when the autonomous vehicle's subsystems or components (e.g., brake pads, tires, air filters, transmission fluid, etc.) are to be replaced or in need of maintenance.

The service center identification module 250 may be configured to select a service center to perform the service on the autonomous vehicle 205. The service center identification module 250 may select the service based on a type of service needed by the autonomous vehicle 205. For example, the service center identification module 250 may select a recharging station when the service needed by the autonomous vehicle 205 is recharging, a car wash station when the service needed by the autonomous vehicle 205 is a car wash, etc. In one example, the service center identification module 250 may select a service center that is alongside or in proximity to the route being taken by the autonomous vehicle 205. In other words, the service center identification module 250 may select a service center that is within a certain distance (e.g., 5 miles) from the autonomous vehicle's current location on the route. Thus, the service center identification module 250 may select a service center that minimizes a travel time associated with the service performed on the autonomous vehicle 205 (e.g., diverting from the route to drive to the service center, and then driving from the service center back to the route). In one example, the service center identification module 250 may select the service center based on a combination of price, types of services offered at the service center, customer reviews, and/or a distance from a current location of the autonomous vehicle 205 to the service center. For example, the service center identification module 250 may select a service center 5 miles from the autonomous vehicle's current location that has a higher rating as compared to a service center 2 miles from the autonomous vehicle's current location. In addition, the service center identification module 250 may give preference to service center(s) that have been previously used to perform services on the autonomous vehicle 205.

The control module 255 may be configured to provide commands to drive the autonomous vehicle 205 along the route from the origin to the destination. In particular, the control module 255 may provide commands to the autonomous vehicle's actuators, thereby controlling steering, acceleration, braking and throttle of the autonomous vehicle 205. Further, the control module 255 may provide commands to divert the autonomous vehicle 205 from the route and travel to the service center. In one example, a secondary route for traveling from a primary route to the service center may be determined, and the control module 255 may provide commands to drive the autonomous vehicle 205 to the service center in accordance with the secondary route. In addition, the control module 255 may provide commands for the autonomous vehicle 205 to return to the route (e.g., the primary route) and continue driving to the destination.

The service authorization module 260 may be configured to notify a user associated with the autonomous vehicle 205 of the service to be performed on the autonomous vehicle 205 and the service center selected to perform the service. For example, the service authorization module 260 may notify the user when an applicable service is to be performed for the autonomous vehicle 205 (e.g., vehicle maintenance, recharging of the vehicle). The service authorization module 260 may send the notification to the computing device 280 (or another computing device preselected by the user). The service authorization module 260 may receive an authorization from the user via the computing device 280 to divert from the route and drive to the service center to enable performance of the service on the autonomous vehicle 205. As a non-limiting example, the service authorization module 260 may notify the user that a fuel level or a battery level of the autonomous vehicle 205 is below a defined threshold, and in response, the service authorization module 260 may receive an authorization from the user to divert from the route taken by the autonomous vehicle 205 to drive to a selected service center to refuel or recharge the autonomous vehicle 205.

The notification module 265 may be configured to notify a user associated with the autonomous vehicle 205 after the service has been performed. In one example, the notification module 265 may send a notification to the computing device 280 after the service is completed (e.g., after the autonomous vehicle 205 is recharged). The notification may include details about the service performed on the autonomous vehicle 205, a cost associated with performing the service (e.g., a cost for recharging or refueling the autonomous vehicle 205, a cost for parts and labor), additional comments related to the service performed on the autonomous vehicle 205, etc.

Certain processing modules may be discussed in connection with this technology and FIG. 2. In one example configuration, a module of FIG. 2 may be considered a service with one or more processes executing on a server or other computer hardware. Such services may be centrally hosted functionality or a service application that may receive requests and provide output to other services or customer devices. For example, modules providing services may be considered on-demand computing that are hosted in a server, cloud, grid, or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

The computing device 210 may comprise, for example, a server computer or any other system providing computing capability. For purposes of convenience, the computing device 210 is referred to herein in the singular. Even though the computing device 210 is referred to in the singular, it is understood that a plurality of computing devices 210 may be employed. As previously described, the computing device 210 may be operating within an autonomous vehicle 205.

The computing device 280 may be representative of a plurality of client devices that may be coupled to the network 275. The computing device 280 may comprise, for example, a processor-based system such as a computer system. Such a computer system may be embodied in the form of a mobile computing device, laptop computer, personal digital assistants, cellular telephones, smartphones, tablet computer systems, or other devices with like capability.

The computing device 280 may include a communication module 282 configured to communicate with the computing device 210 in the autonomous vehicle 205 and/or a service center device 290. For example, the communication module 282 may receive a message, from a service provider at the service center via the service center device 290, which includes a security mechanism 292 indicating that the service provider is authorized to perform the service on the autonomous vehicle 205. After authorization and/or authentication of the service provider, the communication module 282 may instruct the autonomous vehicle 205 to provide limited control of the autonomous vehicle 205 to the service provider to enable the service to be performed on the autonomous vehicle 205.

The computing device 280 may include an authentication module 284 configured to authenticate and/or authorize the service provider at the service center to perform the service on the autonomous vehicle 205. In one example, the authentication module 284 may authenticate the service provider based on a security mechanism provided by the service provider via the service center device 290. The security mechanism may indicate that the service provider is authorized to perform the service on the autonomous vehicle 205. In other words, the security mechanism may include a digital signature or other security measures to verify that the provider of the security mechanism is indeed a service provider that is authenticated to provide services at the service center. In one example, the service provider may provide the security mechanism via the service center device 290 based on a bar code on the autonomous vehicle 205 that includes an identifier (e.g., an Internet Protocol (IP) address) associated with the computing device 280.

The computing device 280 may include or be coupled to an output device 286. The output device 286 may comprise, for example, one or more devices such as cathode ray tubes (CRTs), liquid crystal display (LCD) screens, gas plasma-based flat panel displays, LCD projectors, or other types of display devices, etc.

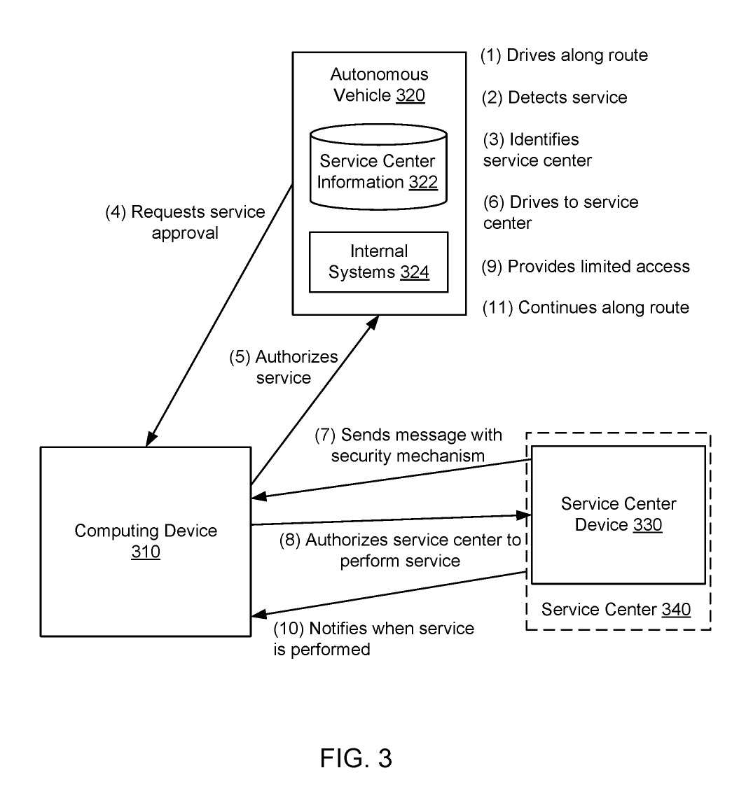

FIG. 3 illustrates an exemplary system for detecting and performing a service on an autonomous vehicle 320 enroute to a destination. While the autonomous vehicle 320 is traveling along a route to the destination, the autonomous vehicle 320 may detect a service to be performed on the autonomous vehicle 320. The service may include refueling or recharging the autonomous vehicle 320. The service may also include performing a repair on the autonomous vehicle 320, performing maintenance on the autonomous vehicle 320, cleaning the autonomous vehicle 320, etc. The autonomous vehicle 320 may include a human operator that performs minimal operation of the autonomous vehicle 320. Alternatively, the autonomous vehicle 320 may operate without a human operator.

In one configuration, the autonomous vehicle 320 may detect when the service is to be performed based on a trigger from one or more internal systems 324 of the autonomous vehicle 320. For example, an internal system 324 may indicate when a fuel level or battery level of the autonomous vehicle 320 is below a defined threshold, when a tire pressure level is below a defined threshold, when an engine oil level is below a defined threshold, etc. In other words, the internal systems 324 may sense a relatively low fuel level, battery level, engine oil level, etc. and as a result, the internal systems 324 may generate an alert notifying that a particular service is due to be performed on the autonomous vehicle 320. As non-limiting examples, an internal system 324 may generate an alert when a gasoline level is less than a quarter full, when a remaining battery level is less than 10% or when a current range of the autonomous vehicle 320 is 50 miles or less. These values may be user-defined settings. In these examples, the alert may trigger detection of a particular service (e.g., recharging or refueling) to be performed on the autonomous vehicle 320. As further non-limiting examples, an internal system 324 may generate an alert when a sensor is malfunctioning, possibly due to debris or dust on an external surface of the sensor. In this example, the alert may trigger detection of a particular service (e.g., car washing) to be performed on the autonomous vehicle 320.

After the autonomous vehicle 320 detects a type of service to be performed, the autonomous vehicle 320 may select a particular service center 340 to perform the service on the autonomous vehicle 320. The autonomous vehicle 320 may select a service center 340 that is within a certain distance (e.g., 3 miles) from the route being taken to the destination, in order to minimize a distance traveled by the autonomous vehicle 320. In other words, the autonomous vehicle 320 may attempt to minimize an amount of time involved with having the service performed (e.g., diverting from the route and driving to the service center 340, and then driving from the service center 340 back to the route). In addition, the autonomous vehicle 320 may attempt to select a service center 340 that is in the direction of the destination, and does not cause the autonomous vehicle 320 to travel backward on the route, thereby improving the distance and/or time involved with having the service performed.

In one configuration, the autonomous vehicle 320 may select the service center 340 using service center information 322, which may include prices, customer reviews, service center capabilities, etc. for a plurality of service centers in a plurality of geographic locations. For example, the autonomous vehicle 320 may identify a list of candidate service centers that are each capable of performing the service that is needed for the autonomous vehicle 320. The autonomous vehicle 320 may generate the list by searching the service center information 322 for applicable service centers within a defined distance (which can be user defined) from the autonomous vehicle's current position on the route to the destination. The service center information 322 may be locally stored at the autonomous vehicle 320 or stored on an external system located across a network. In one example, the autonomous vehicle 320 may identify relevant service centers that are within the defined distance from the autonomous vehicle's current position on the route to the destination. The autonomous vehicle 320 may narrow down the number of candidate service centers on the list based on a combination of the price, customer reviews, a distance from the autonomous vehicle's current location to the service center 340, or other types of information for each of the candidate service centers. From the list, the autonomous vehicle 320 may select a particular service center 340 to perform the service on the autonomous vehicle 320.

As a non-limiting example, when the autonomous vehicle 320 is traveling along the route to the destination, the autonomous vehicle 320 may detect that brake pads on the autonomous vehicle 320 have reached a defined limit and need to be replaced. The autonomous vehicle 320 may identify five vehicle service centers that are within a defined distance (e.g., five miles) from the autonomous vehicle's current position on the route to the destination. The autonomous vehicle 320 may determine that each of the five vehicle service centers provide brake pad replacement services. The autonomous vehicle 320 may communicate with an external system in order to obtain service center information 322, such as pricing information for each of the five vehicle service centers. In addition, the autonomous vehicle 320 may communicate with the external system in order to obtain customer review information for each of the five vehicle service centers. Alternatively, the service center information 322 may be locally stored at the autonomous vehicle 320. Based on the prices and the customer reviews, the autonomous vehicle 320 may select a particular vehicle service center from the list of five vehicle service centers. In one example, the autonomous vehicle 320 may select the vehicle service center based, in part, on user settings. For example, the user settings may indicate that the autonomous vehicle 320 is to select the vehicle service center that can perform the service at a lowest price as compared to the other vehicle service centers on the list.

In one configuration, after detecting the service to be performed and identifying the service center 340 to perform the service, the autonomous vehicle 320 may notify a user associated with the autonomous vehicle 320. The user may be an owner or operator of the autonomous vehicle 320 or an authorized individual that is selected by the user. The autonomous vehicle 320 may send a notification to a computing device 310 associated with the user. The notification may indicate the particular service that is to be performed on the autonomous vehicle 320, as well as the service center 340 that has been selected to perform the service. In other words, the notification may be a request for the user to approve performance of the service at the selected service center 340. If the user approves of the service, then the user may send a message to the autonomous vehicle 320 via the computing device 310 authorizing the service to be performed. The authorization from the computing device 310 may authorize the autonomous vehicle 320 to divert from the route and drive to the service center 340 for performance of the service.

The autonomous vehicle 320 may divert from the route and drive to the service center 340 for performance of the service after receiving authorization from the computing device 310. The autonomous vehicle 320 may drive to the service center 340 by providing commands to control the autonomous vehicle's actuators, thereby controlling steering, acceleration, braking and throttle of the autonomous vehicle 320. In one example, the autonomous vehicle 320 may determine an address, geographical coordinates, etc. associated with the service center 340, and then may accordingly provide instructions to drive the autonomous vehicle 320 to that location. The autonomous vehicle 320 may generate a secondary route for diverting from a primary route and traveling to the service center 340, and the autonomous vehicle 320 may drive to the service center 340 according to the secondary route.

The autonomous vehicle 320 may arrive at the service center 340 and the service may be performed on the autonomous vehicle 320 by a service provider at the service center 340. Non-limiting examples of the service provider may include a fuel station attendant, a charging station attendant, a maintenance worker, a repair person, etc. The service provider may use a service center device 330, such as a mobile device (e.g., a hand-held scanner) to read or scan a two-dimensional (2D) matrix code attached to the autonomous vehicle 520. For example, the matrix code may include a quick response (QR) code or a barcode attached to the autonomous vehicle's windshield. The matrix code may store information about the autonomous vehicle's user (e.g., an owner or operator of the autonomous vehicle 320), such as the user's name, email address, phone number, bank information, vehicle information, etc.

The service center device 330 may scan the matrix code and generate a message to send to the computing device 310. For example, the computing device 510 may be owned or operated by the autonomous vehicle's user. The message may be a short messaging service (SMS) message, text message, electronic mail, a voice message, etc. The message may indicate that the autonomous vehicle 320 has arrived at the service center 340. In addition, the message may include a request for the autonomous vehicle's user to specify a type of service to be performed on the autonomous vehicle 320. In one example, the message may include sales or promotions that are currently ongoing for specific services at the service center 340. As a non-limiting example, the message may indicate that the service center 340 is currently performing free car washes with an oil change. The service center device 330 may send the message to the user's computing device 310 using user identification information included in the matrix code, such as the user's email address or phone number.

In one configuration, the message from the service center device 330 may include a digital signature, an electronic signature or other security measures to prove that the sender of the message is indeed a service provider that is authenticated to provide services at the service center 340. In other words, the user may be assured that the autonomous vehicle 320 is being treated by an authentic service provider. Therefore, unauthorized users may be unable to use a device to scan the matrix code and send a message to the autonomous vehicle's user under false pretenses of being a legitimate service provider. In this case, an unsuspecting user may unknowingly provide the unauthorized user with access to the autonomous vehicle 320. Therefore, the security mechanism included in the message may ensure the autonomous vehicle's user that the autonomous vehicle 320 is being treated by an authorized individual at the service center 340.

The autonomous vehicle's user may send, via the computing device 310, an authorization message to the service center device 330 to authorize the service center 340 to perform services on the autonomous vehicle 320. The authorization message may be sent after the message with the security mechanism is received from the service center device 330. The authorization message may specific a particular service to be performed on the autonomous vehicle 320, as well as other details about the service to be performed.

In one example, while sending the authorization message to the service center device 330, the computing device 310 may also instruct the autonomous vehicle 320 to provide limited access or control to enable performance of the service on the autonomous vehicle 520. For example, the autonomous vehicle 320 may be instructed to unlock the doors to allow the service provider access to inside the autonomous vehicle 320. In another example, the autonomous vehicle 320 may be instructed to open a fuel tank door or charging door so that the service provider can refuel or recharge the autonomous vehicle 320. In another example, the autonomous vehicle 320 may be instructed to allow the service provider to operate the autonomous vehicle 520 using a manual driving mode for purposes of driving to and from a service garage, etc. As a non-limiting example, the autonomous vehicle 320 may be driven within 50 yards with respect to an initial location after arriving at the service center 340.

In one example, the service center device 330 may send an acknowledgement of the user's instructions to the computing device 310. The service provider may perform the service on the autonomous vehicle 320 at the service center 340. The service provider may send, via the service center device 330, a message to the autonomous vehicle's user when the service is complete. The message may include a summary of the service performed, a cost associated with the service, and additional comments related to the service performed on the autonomous vehicle 320. In one example, the user's billing information may already be known (e.g., through the matrix code or from previous service transactions) and the service provider may automatically charge the user upon authorization, or alternatively, the message may request the user to provide the billing information and authorize payment. The user may receive the message and, via the computing device 310, authorize payment for the service.

In one example, the autonomous vehicle 320 may detect when the service has been completed. For example, the computing device 310 may indicate to the autonomous vehicle 320 that the service has been completed. After the service is completed, the autonomous vehicle 320 may drive from the service center 340 back to the route and continue driving to the destination.

In one configuration, the autonomous vehicle 320 may include a human operator that performs minimal operations. In this configuration, the autonomous vehicle 320 may automatically detect enroute when a service is to be performed and identify an appropriate service center 340 along the route. The autonomous vehicle 320 may autonomously travel from the route to the service center 340. When the autonomous vehicle 320 arrives at the service center 340, the human operator may perform some tasks associated with performing the service on the autonomous vehicle 320 (e.g., opening a fuel door, paying for the service). After the service is completed, the human operator may instruct the autonomous vehicle 320 to operate in an autonomous driving mode. In this case, the autonomous vehicle 320 may autonomously drive from the service center 340 back to the route and continue along the route to the destination. In this configuration, the tasks of detecting the service, identifying the service center 340, driving to the service center 340, returning back to the route, etc. may be performed by the autonomous vehicle 320 with minimal or no input from the human operator.

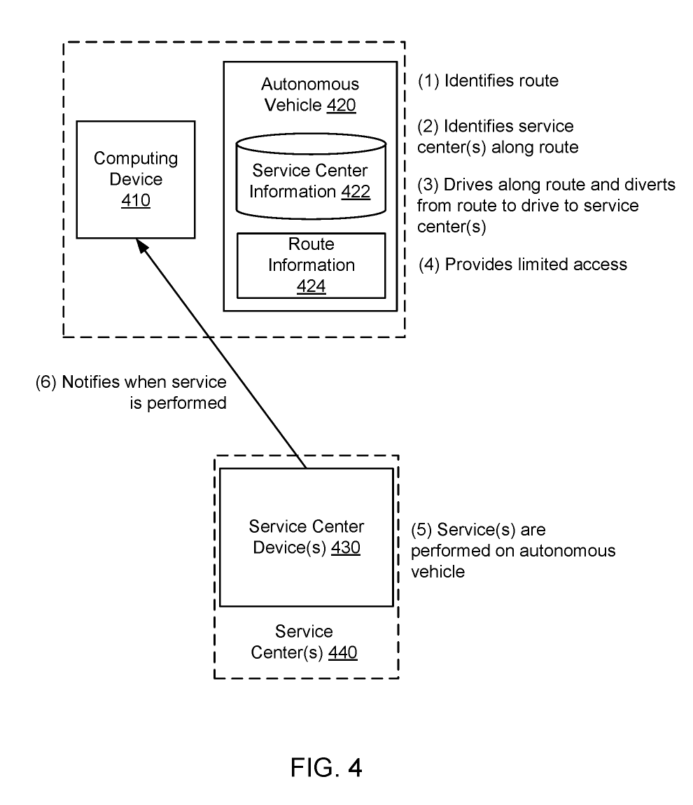

FIG. 4 illustrates an example of a system and related operations for performing service(s) on an autonomous vehicle 420 enroute to a destination. The autonomous vehicle 420 may identify route information 424, which may include a route for traveling from an origin to a destination. The route information 424 may include a specific path to be taken by the autonomous vehicle 420 to travel from the origin to the destination. In addition, the autonomous vehicle 420 may identify a plurality of service center(s) 440 that are along the route, and those service center(s) 440 may be part of the route information 424. The autonomous vehicle 420 may identify the service center(s) 440 that are along the route using service center information 422 that is locally stored on the autonomous vehicle 420. The autonomous vehicle 420 may identify service center(s) 440 that are less than a defined distance from the route. In addition, the autonomous vehicle 420 may identify service center(s) that are within a certain distance from each other, depending on a range (in miles or kilometers) of the autonomous vehicle 420. As a non-limiting example, if a total range of the autonomous vehicle 420 is 300 miles, the autonomous vehicle 420 may select adjacent service centers 440 along the route to be no more than 275 miles apart, thereby ensuring that the autonomous vehicle 420 has sufficient battery charge or fuel to travel between adjacent service centers 440. In this example, the margin between the total range and the distance between adjacent service centers 440 is 25 miles, but this value may vary and may be an adjustable user setting.

In one example, the autonomous vehicle 420 may travel from the origin to the destination in accordance with the route information 424. For example, the autonomous vehicle 420 may divert from the route and drive to each of the service center(s) 440 identified along the route. In one example, the autonomous vehicle 420 may drive to each of the service center(s) 440 to refuel or recharge. When the autonomous vehicle 420 arrives at the service center 440, the autonomous vehicle 420 may provide limited access to enable a service provider at the service center 440 to perform the service (e.g., refueling or recharging the autonomous vehicle 420). The service may be performed on the autonomous vehicle 420, and a service center device 430 associated with the service provider at the service center 440 may send a notification to a computing device 410 associated with a user or operator of the autonomous vehicle 420, where the notification may include details about the service performed on the autonomous vehicle 420.

In this configuration, the autonomous vehicle 420 may not detect in real-time when a service (e.g., refueling or recharging) is to be performed. In other words, in this configuration, the autonomous vehicle 420 may not detect in real-time when a current range of the autonomous vehicle 420 falls below a defined threshold (e.g., 50 miles). Rather, the route information 424 may pre-plan the route and the service center(s) 440 at which the autonomous vehicle 420 is to stop at when traveling along the route. In this case, the route information 424 may be determined in advance, such that adjacent service centers 440 along the route are not separated by a distance that is greater than a total range of the autonomous vehicle 420. In other words, if a total range of the autonomous vehicle 420 is 400 miles, then the route information 424 may not define the route to include adjacent service centers 440 that are 420 miles apart.

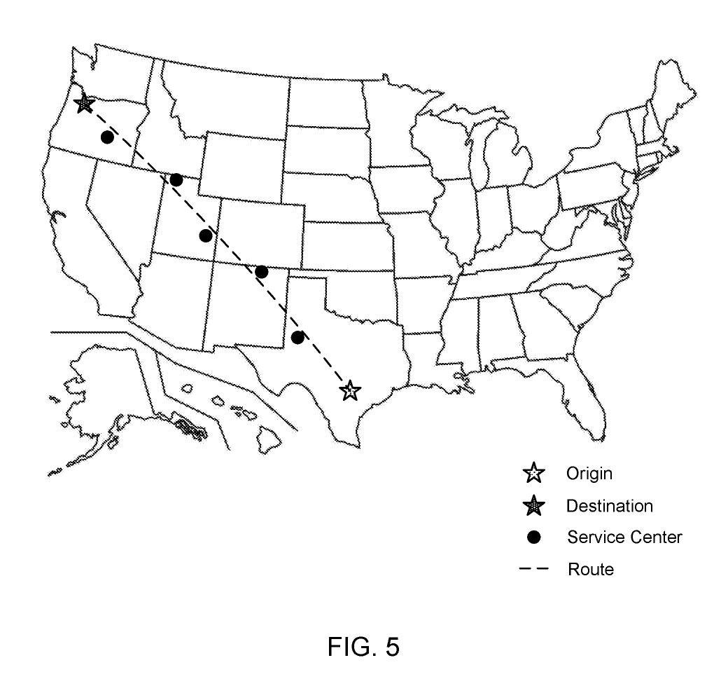

FIG. 5 illustrates an example of a route that is traveled by a self-driving electric truck. In this example, the self-driving truck may start at an origin (e.g., Austin, Tex.) and travel to a destination (e.g., Portland, Oreg.) along the route. A distance between the origin and the destination may be approximately 2050 miles. The self-driving electric truck may have a range of 500 miles before the self-driving electric truck's batteries are to be recharged. In this example, the self-driving electric truck may pre-plan the route to include preselected service centers along the route. The preselected service centers may be approximately 450 miles from each other. In other words, adjacent service centers along the route may be preselected to be approximately 450 miles from each other, such that the self-driving electric truck does not run out of battery charge when driving between adjacent service centers. The self-driving electric truck may stop at each preselected service center (e.g., for recharging) along the route when traveling to the destination. As a result, the self-driving electric truck can drive the entire 2050 miles of the journey while automatically identifying and driving to the service centers for recharging, thereby enabling the self-driving electric truck to complete the journey with minimal or no human intervention.

In an alternative configuration, the self-driving truck may start at the origin (e.g., Austin, Tex.) and travel to the destination (e.g., Portland, Oreg.) along the route. The distance between the origin and the destination may be approximately 2050 miles, and the self-driving electric truck may have a range of 500 miles. In this example, the self-driving electric truck may start driving on the route and when a current range falls below a defined threshold (e.g., 50 miles), the autonomous vehicle may identify and drive to a service center that is along or in proximity to the route. The service center that is identified may be within a current range (e.g., 50 miles) of the autonomous vehicle. After the service is completed, the autonomous vehicle may drive back to the route and continue towards Portland. The autonomous vehicle may repeat this process until the journey is completed and the self-driving electric truck arrives in Portland. In other words, in this configuration, the self-driving electric truck may not pre-plan or preselect the service centers to stop at. Rather, the self-driving electric truck may determine the service center to stop at when the current range is determined in real-time to fall below the defined threshold.

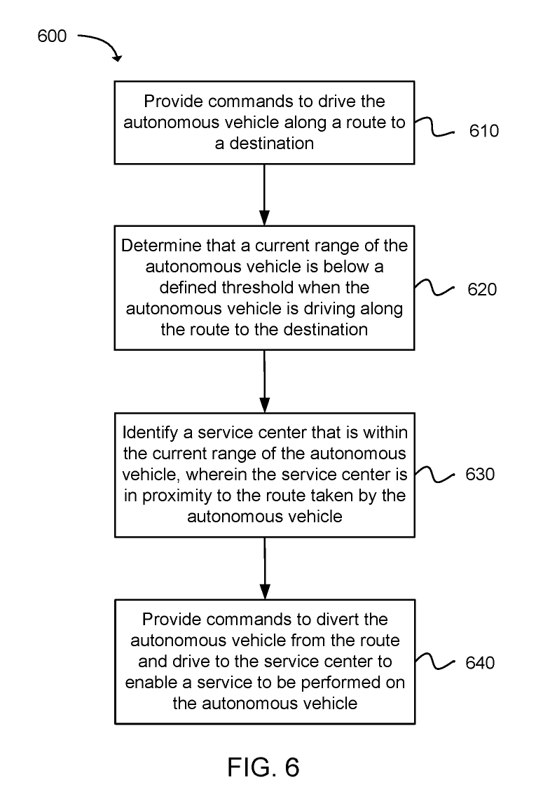

Another example provides functionality 600 of an autonomous vehicle, as shown in the flow chart in FIG. 6. The functionality can be implemented as a method or the functionality can be executed as instructions on a machine, where the instructions are included on at least one computer readable medium or one non-transitory machine readable storage medium. The method may be executed by one or more processors on the machine. The autonomous vehicle may be configured to provide commands to drive the autonomous vehicle along a route to a destination, as in block 610. The autonomous vehicle may be configured to determine that a current range of the autonomous vehicle is below a defined threshold when the autonomous vehicle is driving along the route to the destination, as in block 620. The autonomous vehicle may be configured to identify a service center that is within the current range of the autonomous vehicle, wherein the service center is in proximity to the route taken by the autonomous vehicle, as in block 630. The autonomous vehicle may be configured to provide commands to divert the autonomous vehicle from the route and drive to the service center to enable a service to be performed on the autonomous vehicle, as in block 640.

In one example, the autonomous vehicle may be a self-driving truck. In a further example, the service may include refueling or recharging the autonomous vehicle. In a further example, the autonomous vehicle may provide commands to drive the autonomous vehicle from the service center to the route and continue driving along the route to the destination. In a further example, the autonomous vehicle may provide limited access to the autonomous vehicle to enable a service provider at the service center to perform the service on the autonomous vehicle. In a further example, the autonomous vehicle may send a notification to a computing device after the service has been performed on the autonomous vehicle. In a further example, the autonomous vehicle may identify the service center based on a previously performed service on the autonomous vehicle at the service center. In a further example, the autonomous vehicle may identify the service center based on at least one of: a cost, customer reviews, or a distance from a current location of the autonomous vehicle.

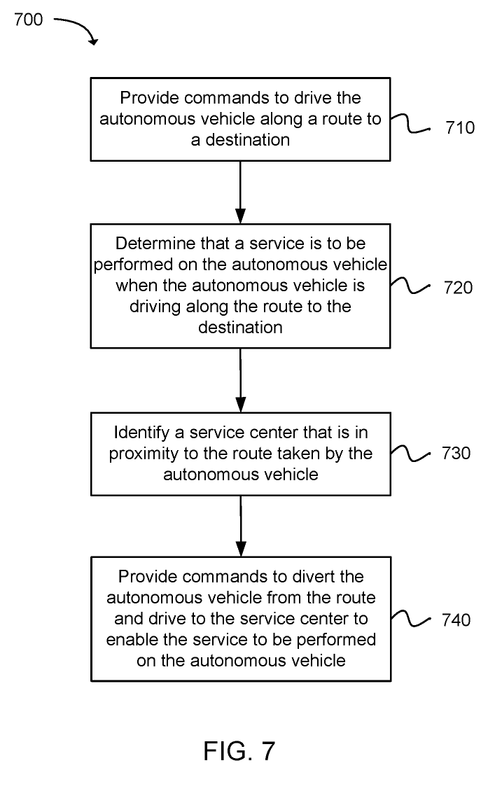

Another example provides functionality 700 of an autonomous vehicle, as shown in the flow chart in FIG. 7. The functionality can be implemented as a method or the functionality can be executed as instructions on a machine, where the instructions are included on at least one computer readable medium or one non-transitory machine readable storage medium. The method may be executed by one or more processors on the machine. The autonomous vehicle may be configured to provide commands to drive the autonomous vehicle along a route to a destination, as in block 710. The autonomous vehicle may be configured to determine that a service is to be performed on the autonomous vehicle when the autonomous vehicle is driving along the route to the destination, as in block 720. The autonomous vehicle may be configured to identify a service center that is in proximity to the route taken by the autonomous vehicle, as in block 730. The autonomous vehicle may be configured to provide commands to divert the autonomous vehicle from the route and drive to the service center to enable the service to be performed on the autonomous vehicle, as in block 740.

In one example, the autonomous vehicle may be a self-driving truck. In a further example, the service may include at least one of: refueling or recharging the autonomous vehicle, performing a repair on the autonomous vehicle, performing maintenance on the autonomous vehicle, or cleaning the autonomous vehicle. In a further example, the autonomous vehicle may provide commands to drive the autonomous vehicle from the service center to the route and continue driving along the route to the destination. In a further example, the autonomous vehicle may identify the service center based on a previously performed service on the autonomous vehicle at the service center; or identify the service center based on at least one of: a cost, customer reviews, or a distance from a current location of the autonomous vehicle. In a further example, the autonomous vehicle may determine that the service is to be performed on the autonomous vehicle based on an alert generated by one or more internal systems of the autonomous vehicle.

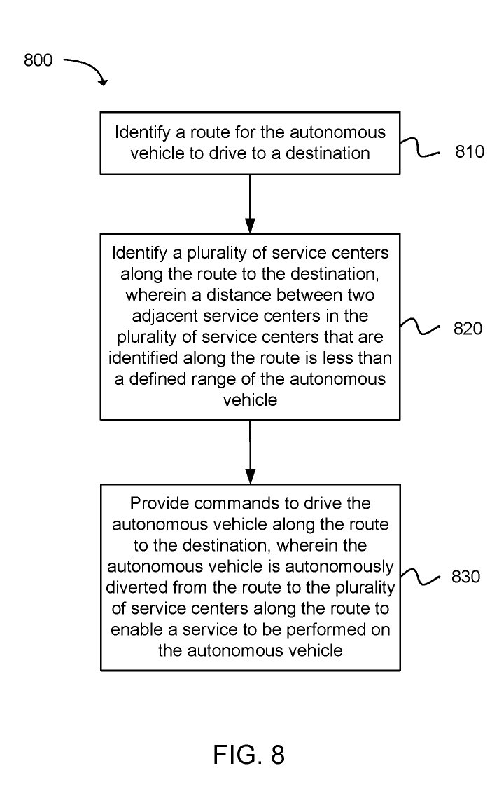

Another example provides functionality 800 of an autonomous vehicle, as shown in the flow chart in FIG. 8. The functionality can be implemented as a method or the functionality can be executed as instructions on a machine, where the instructions are included on at least one computer readable medium or one non-transitory machine readable storage medium. The method may be executed by one or more processors on the machine. The autonomous vehicle may be configured to identify a route for the autonomous vehicle to drive to a destination, as in block 810. The autonomous vehicle may be configured to identify a plurality of service centers along the route to the destination, wherein a distance between two adjacent service centers in the plurality of service centers that are identified along the route is less than a defined range of the autonomous vehicle, as in block 820. The autonomous vehicle may be configured to provide commands to drive the autonomous vehicle along the route to the destination, wherein the autonomous vehicle is autonomously diverted from the route to the plurality of service centers along the route to enable a service to be performed on the autonomous vehicle, as in block 830.

In one example, the autonomous vehicle may be a self-driving truck. In a further example, the service may include refueling or recharging the autonomous vehicle. In a further example, the autonomous vehicle may provide limited access to the autonomous vehicle to enable a service provider at the service center to perform the service on the autonomous vehicle. In a further example, the autonomous vehicle may send a notification to a computing device after the service has been performed on the autonomous vehicle. In a further example, the plurality of service centers are within a defined distance from the route to the destination.

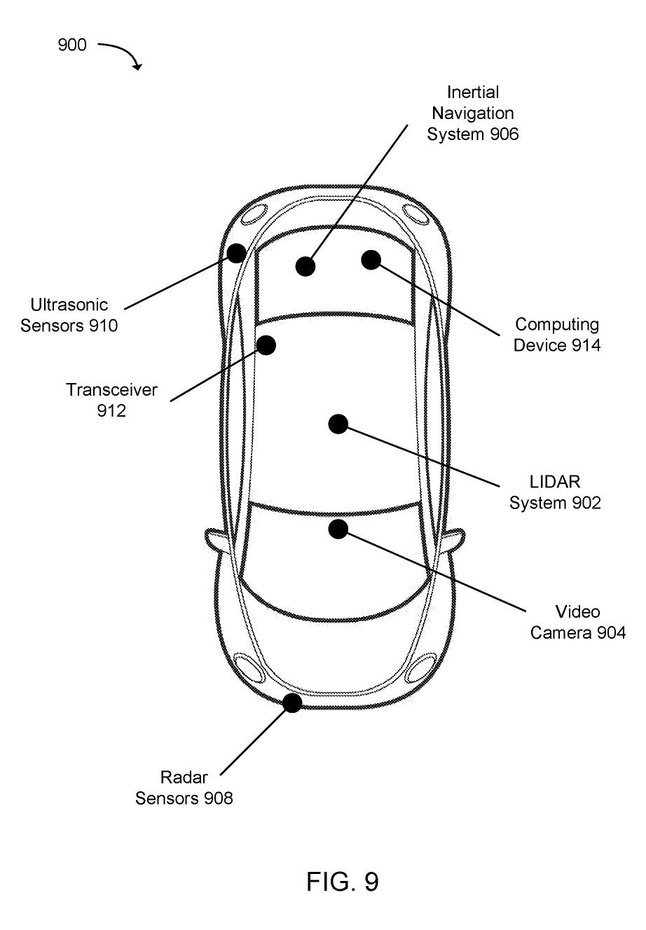

FIG. 9 illustrates an example of an autonomous vehicle 900 that is capable of sensing a surrounding environment and navigating itself to a destination. The autonomous vehicle 900 may be classified as a “Level 0” autonomous vehicle, a “Level 1” autonomous vehicle, a “Level 2” autonomous vehicle, a “Level 3” autonomous vehicle, or a “Level 4” autonomous vehicle. In Level 0, a driver may control the autonomous vehicle 900 at substantially all times. The driver may be in complete and sole control of primary vehicle controls, such as brake, steering, throttle and motive power. In Level 1, one or more individual controls may be automated in the autonomous vehicle 900, such as electronic stability control or automatic braking, in which the vehicle may automatically assist with braking to enable the driver to regain control of the vehicle or stop faster than possible by acting alone. In Level 2, at least two controls may be automated in unison in the autonomous vehicle 900, such as adaptive cruise control in combination with lane keeping. In Level 3, the driver may cede full control of substantially all safety-critical functions to the autonomous vehicle 900 under certain traffic or environmental conditions. The autonomous vehicle 900 may sense when certain conditions necessitate the driver to retake control of the autonomous vehicle 900 and a sufficiently comfortable transition time may be provided for the driver to retake control of the autonomous vehicle 900. In Level 4, the autonomous vehicle 900 may perform substantially all safety-critical driving functions and monitor roadway conditions for an entire trip. The driver may provide destination or navigation input, but the driver may not be expected to control the autonomous vehicle 900 at any time during the trip. As the autonomous vehicle 900 may control all functions from start to stop, including parking functions, in level 4, the autonomous vehicle 900 may include both occupied and unoccupied vehicles. In one example, the autonomous vehicle 900 may be restricted to operating in certain environments or under certain conditions based on government regulations.

The autonomous vehicle 900 may include, but is not limited to, cars, trucks, motorcycles, buses, recreational vehicles, golf carts, trains, and trolleys. The autonomous vehicle 900 may include an internal combustion engine that operates using liquid fuels (e.g., diesel, gasoline). Alternatively, the autonomous vehicle 900 may include one or more electric motors that operate using electrical energy stored in batteries. The autonomous vehicle 900 may include, but is not limited to, a light detection and ranging (LIDAR) system 902, a video camera 904, an inertial navigation system 906, radar sensors 908, ultrasonic sensors 910, a transceiver 912, and a computing device 914 that, while working together in combination, enable the autonomous vehicle 900 to sense the environment and navigate to the destination with reduced user input. The autonomous vehicle 900 may use information captured by the various sensors, cameras, etc. to safely drive the autonomous vehicle 900 along a route to a destination, while avoiding obstacles and obeying traffic laws. The autonomous vehicle 900 may perform a series of steps when following the route to the destination. For example, the autonomous vehicle 900 may drive 500 meters, turn right, drive 1000 meters, turn left, etc. in order to reach the destination.

The LIDAR system 902 (also known as a laser range finder) may be mounted onto a surface (e.g., a top surface) of the autonomous vehicle 900. The LIDAR system 902 may emit a plurality of light pulses and measure an amount of time for the light pulses to return to the autonomous vehicle 900, thereby allowing the LIDAR system 902 to measure the distance of objects surrounding the autonomous vehicle 900. As a non-limiting example, the LIDAR system 902 may measure the distance of objects within 200 meters from the autonomous vehicle 900.

One or more video cameras 904 may be mounted to a front, rear or side portion of the autonomous vehicle 900. The autonomous vehicle 900 may use the LIDAR system 902 and the video camera 904 to build a three-dimensional (3D) map of the autonomous vehicle's surroundings. The 3D map may capture a 360-degree view around the autonomous vehicle 900. In one example, the 3D map may capture the autonomous vehicle's surroundings within 200 meters. The 3D map may include a variety of features, such as road edges, road signs, lane markings, guardrails, overpasses, etc. The 3D map may indicate stationary objects, such as buildings, telephone poles, mailboxes, etc. In addition, the 3D map may indicate moving objects, such as other vehicles, bicyclists, pedestrians, etc.

In one example, the 3D map generated using the LIDAR system 902 and the video camera 904 may be correlated with high-resolution maps of the world. The high-resolution maps may indicate lane markings, terrain, elevation, speed limits, and other features related to the route taken by the autonomous vehicle 900 when driving to the destination. In addition, the autonomous vehicle 900 may position or localize itself within the 3D map. In other words, the autonomous vehicle 900 may determine its position in relation to the objects included in the 3D map. The autonomous vehicle 900 may determine its position by using the inertial navigation system 906. The inertial navigation system 906 may calculate a position, orientation, and velocity (i.e., direction and speed of movement) of the autonomous vehicle 900.

The inertial navigation system 906 may include a combination of gyroscopes, altimeters, tachometers, gyroscopes and other motion-sensing devices in order to calculate the autonomous vehicle's position. The inertial navigation system 906 may determine an initial position and velocity, and thereafter compute the autonomous vehicle's updated position and velocity by integrating information received from the motion-sensing devices. In one example, a GPS receiver (not shown in FIG. 9) may provide the initial position of the autonomous vehicle 900 (e.g., latitude, longitude, altitude). Thereafter, the autonomous vehicle 900 may use the inertial navigation system 906 to determine its position in relation to the objects on the 3D map. As the autonomous vehicle 900 drives to the destination, updated positional information from the inertial navigation system 906 may continually update the 3D map of the autonomous vehicle's surroundings.

The radar sensors 908 may be mounted on front, rear and/or side sections of the autonomous vehicle 900. The radar sensors 908 may monitor a position of proximately-located vehicles on the road, such as vehicles immediately behind or in front of the autonomous vehicle 900. In addition, ultrasonic sensors 910 may be used to measure a distance to proximately-located objects, such as curbs or other vehicles when the autonomous vehicle 900 is parking. The radar sensors 908 and the ultrasonic sensors 910 may be used when generating and updating the 3D map of the autonomous vehicle's surroundings. For example, the radar sensors 908 and the ultrasonic sensors 910 may detect objects that are located in proximity to the autonomous vehicle 900 and those objects may be included in the 3D map of the autonomous vehicle's surroundings.

The transceiver 912 may allow the autonomous vehicle 900 to communicate with other devices or systems when driving to the destination. For example, the transceiver 912 may communicate with other vehicles on the road using vehicle-to-vehicle (V2V) communication. V2V communication may use dedicated short-range communications (DSRC) and operate in the 5.9 GHz frequency range. The range for V2V communication may be approximately 300 meters. In addition, the transceiver 912 may communicate with computing devices (e.g., mobile phones, tablet computers) that provide instructions to the autonomous vehicle 900 via wireless communication standards, such as Third Generation Partnership Project (3GPP) Long Term Evolution (LTE), Wi-Fi, WiMAX, Bluetooth, etc. The above list of wireless communication standards is non-limiting and is intended to include related wireless communication standards that are forthcoming. In one example, the transceiver 912 may enable the autonomous vehicle 900 to receive messages from the computing devices, such as messages requesting a pickup, messages instructing the autonomous vehicle 900 to perform a particular task, etc.

The computing device 914 may receive information collected and/or generated from the LIDAR system 902, the video cameras 904, the inertial navigation system 906, the radar sensors 908, the ultrasonic sensors 910, and the transceiver 912. The computing device 914 may process the information (e.g., the 3D map of the vehicle's surroundings) in real-time and determine whether to modify the autonomous vehicle's current velocity and orientation in response to the sensed environment. The computing device 914 may use the received information in order to provide commands to the autonomous vehicle's actuators, thereby controlling steering, acceleration, braking and throttle of the autonomous vehicle 900. The computing device 914 may perform the tasks of localization, 3D mapping, obstacle avoidance, path planning, etc. multiple times per second until the autonomous vehicle 900 reaches the destination. In addition, the computing device 914 may include a data store that stores various types of information, such as road speed limits, traffic accidents, road construction work, etc. The computing device 914 may receive the information from a server via the transceiver 912. The computing device 914 may use the various types of information received from the server for making intelligent decisions when guiding the autonomous vehicle 900 to the destination,

In one example, the computing device 914 or a portion of the computing device 914 may be in idle mode (e.g., a low power mode or a standby mode) when the autonomous vehicle 900 is shut off. For example, the computing device 914 may be in idle mode when the autonomous vehicle 900 is parked in a parking space. The computing device 914 may periodically check for messages that are received when the computing device 914 is in idle mode. For example, the computing device 914 may periodically check for messages received from a mobile device. The computing device 914 may transition from idle mode into an on mode upon receiving a message that instructs the autonomous vehicle 900 to perform a task (e.g., drive to a destination). In one configuration, the computing device 914 or the portion of the computing device 914 may be powered via energy harvesting when in idle mode. For example, the computing device 914 may derive energy from external sources in order to receive messages from the device. The external sources may include, but is not limited to, solar power, battery power, thermal power, wind energy, and kinetic energy.

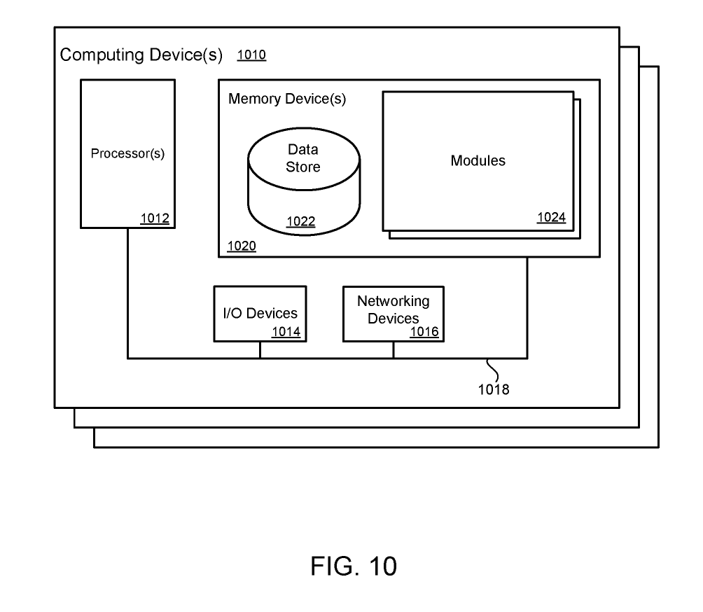

FIG. 10 illustrates a computing device 1010 on which modules of this technology may execute. A computing device 1010 is illustrated on which a high level example of the technology may be executed. The computing device 1010 may include one or more processors 1012 that are in communication with memory devices 1020. The computing device may include a local communication interface 1018 for the components in the computing device. For example, the local communication interface may be a local data bus and/or any related address or control busses as may be desired.

The memory device 1020 may contain modules 1024 that are executable by the processor(s) 1012 and data for the modules 1024. The modules 1024 may execute the functions described earlier. A data store 1022 may also be located in the memory device 1020 for storing data related to the modules 1024 and other applications along with an operating system that is executable by the processor(s) 1012.

Other applications may also be stored in the memory device 1020 and may be executable by the processor(s) 1012. Components or modules discussed in this description that may be implemented in the form of software using high programming level languages that are compiled, interpreted or executed using a hybrid of the methods.

The computing device may also have access to I/O (input/output) devices 1014 that are usable by the computing devices. An example of an I/O device is a display screen that is available to display output from the computing devices. Other known I/O device may be used with the computing device as desired. Networking devices 1016 and similar communication devices may be included in the computing device. The networking devices 1016 may be wired or wireless networking devices that connect to the internet, a LAN, WAN, or other computing network.

The components or modules that are shown as being stored in the memory device 1020 may be executed by the processor 1012. The term “executable” may mean a program file that is in a form that may be executed by a processor 1012. For example, a program in a higher level language may be compiled into machine code in a format that may be loaded into a random access portion of the memory device 1020 and executed by the processor 1012, or source code may be loaded by another executable program and interpreted to generate instructions in a random access portion of the memory to be executed by a processor. The executable program may be stored in any portion or component of the memory device 1020. For example, the memory device 1020 may be random access memory (RAM), read only memory (ROM), flash memory, a solid state drive, memory card, a hard drive, optical disk, floppy disk, magnetic tape, or any other memory components.

The processor 1012 may represent multiple processors and the memory 1020 may represent multiple memory units that operate in parallel to the processing circuits. This may provide parallel processing channels for the processes and data in the system. The local interface 1018 may be used as a network to facilitate communication between any of the multiple processors and multiple memories. The local interface 1018 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

As used herein, the term “processor” can include general purpose processors, specialized processors such as VLSI, FPGAs, and other types of specialized processors, as well as base band processors used in transceivers to send, receive, and process wireless communications.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. An autonomous vehicle, comprising:
one or more processors;
a memory device including a data store to store a plurality of data and instructions that, when executed by the one or more processors, cause the one or more processors to:
provide commands to drive the autonomous vehicle along a route to a destination;
determine that a current range of the autonomous vehicle is below a defined threshold when the autonomous vehicle is driving along the route to the destination;
identify a service center that is within the current range of the autonomous vehicle, and the service center is in proximity to the route taken by the autonomous vehicle; and
provide commands to divert the autonomous vehicle from the route and drive to the service center to enable a service to be performed on the autonomous vehicle.

2. The autonomous vehicle of claim 1, wherein the service includes refueling or recharging the autonomous vehicle.

3. The autonomous vehicle of claim 1, wherein the plurality of data and instructions, when executed by the processor, cause the processor to: provide commands to drive the autonomous vehicle from the service center to the route and continue driving along the route to the destination.

4. The autonomous vehicle of claim 1, wherein the plurality of data and instructions, when executed by the processor, cause the processor to: provide limited access to the autonomous vehicle to enable a service provider at the service center to perform the service on the autonomous vehicle.

5. The autonomous vehicle of claim 1, wherein the plurality of data and instructions, when executed by the processor, cause the processor to: send a notification to a computing device after the service has been performed on the autonomous vehicle.

6. The autonomous vehicle of claim 1, wherein the plurality of data and instructions, when executed by the processor, cause the processor to: identify the service center based on a previously performed service on the autonomous vehicle at the service center.

7. The autonomous vehicle of claim 1, wherein the plurality of data and instructions, when executed by the processor, cause the processor to: identify the service center based on at least one of: a cost, customer reviews, or a distance from a current location of the autonomous vehicle.

8. The autonomous vehicle of claim 1, wherein the autonomous vehicle is a self-driving truck.

9. An autonomous vehicle, comprising:
one or more processors;
a memory device including a data store to store a plurality of data and instructions that, when executed by the one or more processors, cause the one or more processors to:
provide commands to drive the autonomous vehicle along a route to a destination;
determine that a service is to be performed on the autonomous vehicle when the autonomous vehicle is driving along the route to the destination;
identify a service center that is in proximity to the route taken by the autonomous vehicle; and
provide commands to divert the autonomous vehicle from the route and drive to the service center to enable the service to be performed on the autonomous vehicle.

10. The autonomous vehicle of claim 9, wherein the service includes at least one of: refueling or recharging the autonomous vehicle, performing a repair on the autonomous vehicle, performing maintenance on the autonomous vehicle, or cleaning the autonomous vehicle.

11. The autonomous vehicle of claim 9, wherein the plurality of data and instructions, when executed by the processor, cause the processor to: provide commands to drive the autonomous vehicle from the service center to the route and continue driving along the route to the destination.

12. The autonomous vehicle of claim 9, wherein the plurality of data and instructions, when executed by the processor, cause the processor to:
identify the service center based on a previously performed service on the autonomous vehicle at the service center; or
identify the service center based on at least one of: a cost, customer reviews, or a distance from a current location of the autonomous vehicle.

13. The autonomous vehicle of claim 9, wherein the plurality of data and instructions, when executed by the processor, cause the processor to: determine that the service is to be performed on the autonomous vehicle based on an alert generated by one or more internal systems of the autonomous vehicle.

14. The autonomous vehicle of claim 9, wherein the autonomous vehicle is a self-driving truck.

15. An autonomous vehicle, comprising:
one or more processors;
a memory device including a data store to store a plurality of data and instructions that, when executed by the one or more processors, cause the one or more processors to:
identify a route for the autonomous vehicle to drive to a destination;
identify a plurality of service centers along the route to the destination, wherein a distance between two adjacent service centers in the plurality of service centers that are identified along the route is less than a defined range of the autonomous vehicle; and
provide commands to drive the autonomous vehicle along the route to the destination, wherein the autonomous vehicle is autonomously diverted from the route to the plurality of service centers along the route to enable a service to be performed on the autonomous vehicle.

16. The autonomous vehicle of claim 15, wherein the service includes refueling or recharging the autonomous vehicle.

17. The autonomous vehicle of claim 15, wherein the plurality of data and instructions, when executed by the processor, cause the processor to: provide limited access to the autonomous vehicle to enable a service provider at the service center to perform the service on the autonomous vehicle.

18. The autonomous vehicle of claim 15, wherein the plurality of data and instructions, when executed by the processor, cause the processor to: send a notification to a computing device after the service has been performed on the autonomous vehicle.

19. The autonomous vehicle of claim 15, wherein the plurality of service centers are within a defined distance from the route to the destination.

20. The autonomous vehicle of claim 15, wherein the autonomous vehicle is a self-driving truck.
